(19) United States
(12) Patent Application Publication
(10) Pub. No.: US 2004/0141175 A1
(43) Pub. Date: Jul. 22, 2004

(54) Method and apparatus for uniform lighting source

(76) Inventors: Leo Baldwin, Portland, OR (US); Frank Evans, Dundee, OR (US)

Correspondence Address: Thomas E. Bejin, YOUNG & BASILE, PC, Suite 624, 3001 West Big Beaver Road, Troy, MI, 48084, US

(21) Appl. No.: 10/616,548

(22) Filed: Feb. 27, 2004

Related U.S. Application Data
(60) Provisional application No. 60/395,499, filed on Jul. 12, 2002.

(51) Int. Cl. G01N 21/88

(52) U.S. Cl. 356/237.2

(57) ABSTRACT

The present invention provides a light source which improves the lighting for objects which include a nontrivial bi-directional reflectance distribution function and a nominal illumination angle. A two dimensional light source is positioned at an angle which is complementary to the nominal illumination angle such that the object is illuminated at its nominal illumination angle.

### CROSS-REFERENCE TO RELATED APPLICATION

This application claims priority from U.S. Serial No. 60/395,499 for METHOD AND APPARATUS FOR UNIFORM LIGHTING SOURCE, filed Jul. 12, 2002.

### FIELD OF THE INVENTION

The present invention relates to illuminating objects.

### BACKGROUND OF THE INVENTION

The way in which an object reflects light can vary from perfectly diffuse, known in the art as Lambertian (after Lambert), to perfectly specular (after speculum, a mirror).

If an object is substantially Lambertian in nature in that the surfaces reflect light with an efficiency which is essentially independent of angle, then the illumination of such an object is relatively simple. In such a case the uniformity of an image of an object relies only upon the uniformity and intensity of the incident illumination. An example of a Lambertian object would be paper, which can be adequately illuminated by a single point-like source of light.

If an object is substantially specular and the desired illumination is bright field illumination, then the light source will be seen directly by the observer. This can be accomplished by placing a camera at an off angle which is the same as the off angle of a light source in so much as the angle of reflection on a specular object complements the angle of incidence. In such a case the source itself must have the characteristics of a Lambertian emitter and must encompass the projected field of view.

Between substantially diffuse reflecting Lambertian objects and substantially specular reflecting objects there exists a very large class of objects for which the surfaces are neither substantially Lambertian nor substantially specular. For these objects, the amount of light reflected from a light source to the observer or sensing device depends both on the intensity of the incident illumination and the angle of incidence.

U.S. Pat. No. 5,822,053 entitled “Machine Vision Light Source with Improved Optical Efficiency”, to Thrailkill; describes a device for constructing an illumination system using light emitting diodes (LEDs) which is substantially uniform in the intensity incident on a given area. This invention by Thrailkill gives no consideration to the uniformity of the angle of incidence of said illumination.

A need has arisen to provide an improved illumination device which more accurately illuminates an object for inspection.

### SUMMARY OF THE INVENTION

The present invention provides a method for illuminating an object including determining a nominal illumination angle for the object and positioning a light source at an angle complementary to the nominal illumination angle of the object.

The present invention also provides for a light source for a manufacturing inspection system. The light source illuminates an object where the object has a nontrivial bi-directional reflectance distribution function and includes a nominal illumination angle. The light source includes a plurality of discrete light sources arranged in two dimensions and positioned at an angle complementary to the nominal illumination angle.

The present invention also provides a device for inspecting semiconductor devices. The semiconductor devices include a nontrivial bi-directional reflectance distribution function and includes a nominal illumination angle. The inspection devices have a sensing element and a lens arrangement. A two dimensional light source is positioned at an angle complementary to the nominal illumination angle.

### BRIEF DESCRIPTION OF THE DRAWINGS

FIG. 1 is a cross section of an illumination device according to the prior art.

FIG. 2 is a flow diagram illustrating the method of the present invention.

FIG. 3 is a cross section of an illumination device according to the present invention.

FIG. 4 is an exploded view of an angular illumination device according to a first preferred embodiment of the present invention.

FIG. 5 is an exploded view of an angular illumination device according to a second preferred embodiment of the present invention.

The description herein makes reference to the accompanying drawings wherein like reference numerals refer to like parts throughout the several views.

### DESCRIPTION OF THE PREFERRED EMBODIMENT

The purpose of this invention is to more uniformly illuminate an object under observation for inspection. Uniform lighting is important to observation as nonuniform lighting may be mistaken for a nonuniformity in the object under observation. Similarly, nonuniformity in the lighting may mask a nonuniformity in the object, which may be a defect. Unlike the prior art, the present invention provides a substantially constant angle of illumination of the object regardless of the location on the object. The present invention thus provides for effective illumination of an object that has a nontrivial bi-directional reflectance distribution function (BRDF) (i.e., somewhere between Lambertian and specular.)

Typically, although the present invention is not so limited, the illumination device of the present invention will be employed for the automated characterization and/or inspection of manufactured parts. These manufactured parts include semiconductors. Classes of semiconductors may have a nontrivial bi-directional reflectance distribution function thereby presenting varying illumination properties from Lambertian to specular. It is well understood that the time necessary to accurately inspect certain manufactured parts such as semiconductors is limited with any error reducing the efficiency of the overall production rate. The present invention reduces errors in inspection associated with illumination and thereby contributes to the overall efficiency of the manufacturing process.

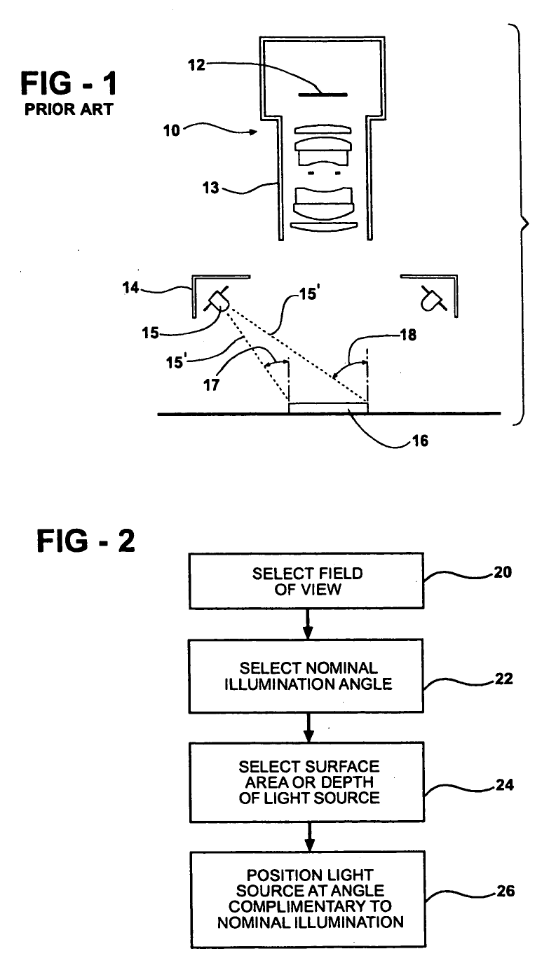

Referring now to FIG. 1, there is shown an illumination device of the prior art. In particular there is generally shown an imaging device 10 which includes a sensing element 12, a lens 13 and an annular illuminator 14. The annular illuminator includes a ring of LEDs 15 which are aimed symmetrically at an object 16. Flux 15′ from LEDs 15 is incident on object 16 at different acute angles 17 and 18, as measured from the normal, depending upon the location of object 16. The present invention provides for a substantially constant angle of illumination compared to the variable angle of illumination provided in the prior art.

With reference to FIG. 2 there is shown a flow diagram illustrating the basic aspects of a method to construct a lighting system according to the present invention. At 20 a user first selects a field of view for the object. Preferably the field of view would subtend the entire object, but it is understood that the field of view could be less, e.g. it could subtend half the object. At 22, a nominal illumination angle is selected for a particular object being imaged. The nominal illumation angle is the angle of illumination, in this example measured from a plane normal to the object, which most effectively illuminates the object under consideration. It is understood that the nominal illumination angle will vary depending upon the qualities of the object being imaged.

The nominal illumination angle may be determined empirically to provide a preferred illumination effect; it may be determined by mathematical modeling of the object, the light source and the sensing apparatus; or it may be restricted to a particular nominal value by the available space for the illumination system. Empirical determination may involve trial and error over an object to determine the optimum angle of illumination. An example of a mathematical approach would be a Monte Carlo ray tracing. A Monte Carlo ray tracing involves the use of a random variable package which creates Monte Carlo ray tracings. An example of a software package capable of such mathematical modeling is sold by Lambda Research Corporation of Littleton, Mass. under the name Trace Pro.

With continued reference to FIG. 2 the largest dimension of the field of view (i.e., the diagonal dimension if the field of view is rectangular) is projected toward the nominal illumination angle which will provide the depth of the light source at 24. This ensures that when the light is constructed it subtends the intended field of view. In particular, the light source has sufficient dimensions and is of sufficient surface area to illuminate the selected area on the object. Thus the light-source is two dimensional and all that is needed for the light source to be two dimensional is depth to determine an angle complementary to the nominal illumination angle. At 26 the light source is positioned at an angle which is complementary to the nominal illumination angle. Positioning the light source in this manner ensures that each point on the object is illuminated at an angle substantially the same as the nominal illumination angle.

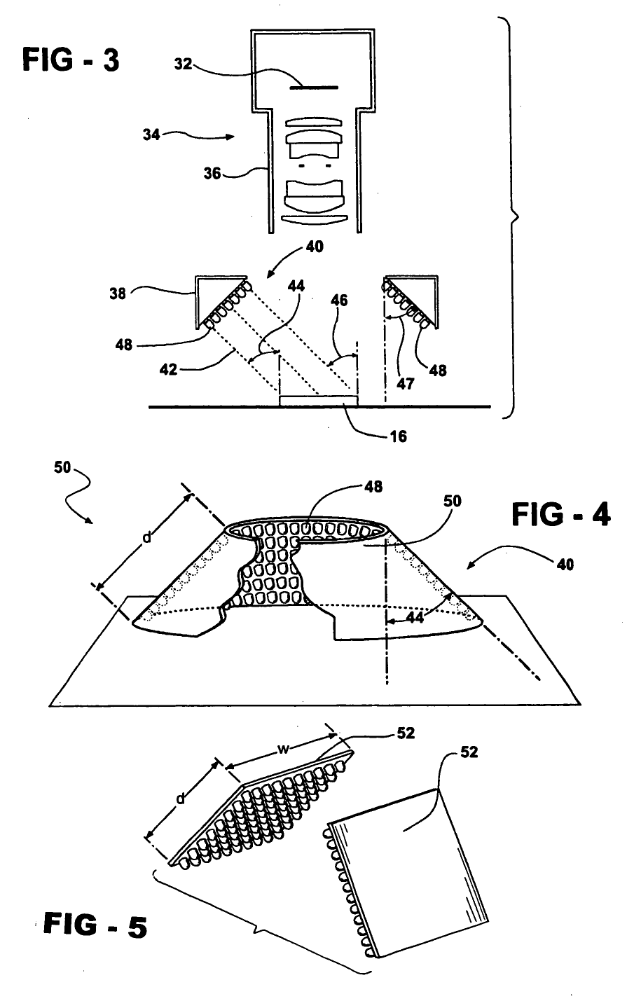

With reference to FIG. 3 there is shown a schematic drawing of an illumination and imaging device 34 according to the present invention. Imaging device 34 includes a sensing element 32, a lens arrangement 36, and a light source 38. Sensing element 32 and lens arrangement 36 may be of any construction including conventional and non-conventional. For example, lens arrangement 36 may have a diverging principle of rays or may be telecentric.

Light source 38 is positioned to illuminate all points of an object 16 at substantially the same angle as shown at 44 and 46. As illustrated light rays or flux 42 from discrete sources 48, which are incident on object 16, are all incident with substantially the same angle 44, 46, on object 16 regardless of the location at which the angle is measured. Thus the angle measured at the nearside, angle 44, and the angle measured on the far side, angle 46, are the same. Providing lighting with the same angle of incidence across an object improves the lighting for objects which are specular to any degree.

With continued reference to FIG. 3, light source 38 is preferably aimed symmetrically at object 16. Symmetric aiming refers to the fact that the light source 38 is positioned at an angle 47 with respect to the perpendicular, with angle 47 being the complement to the nominal angle 44, 46.

As shown in FIG. 3, light source 38 is constructed to subtend the projected dimension and surrounds the object. It is understood that an illumination device could be constructed so as not to entirely subtend the projected dimension. To subtend the projected dimension of the object it is understood that light source 38 has a sufficient surface area. Light source 38 may be of circular symmetry, two-fold symmetry, four-fold symmetry, or be of any other configuration which is best suited to the object and the available space. However, it is understood that the most general case is circular symmetry.

With reference to FIGS. 3-5, light source 38 includes an emitter generally referenced as 40. Emitter 40 may be any of a wide variety of types. For example an emitter may be a bulk emitter such as an electro luminescent surface or a formed polymer light emitting diode surface. In the first preferred embodiment emitter 40 may be fabricated from a plurality of smaller discrete sources 48. Preferably, discrete sources 48 are prepackaged LEDs.

With specific reference to FIG. 4 discrete sources 48 are preferably prepackaged LEDs on a flexible printed wire board formed into a cone 50. Cone 50 has full symmetry and a depth d sufficient to subtend the intended portion of object 16. With reference to FIG. 5 a plurality of discrete light sources 48 could be packaged on a plurality of rigid printed wire boards 52 which can be tiled into an array, which is illustrated as two-fold symmetry. Rigid boards 53 have a depth d and a width w sufficient to subtend an intended portion of object 16. It is understood that tiled light sources 52 could be arranged into any geometry.

While the invention has been described in connection with what is presently considered to be the most practical and preferred embodiment, it is to be understood that the invention is not to be limited to the disclosed embodiments.

What is claimed is:

1. A method for illuminating an object comprising,
determining a nominal illumination angle for the object;
positioning a light source at an angle complimentary to the nominal illumination angle of the object.

2. A method as in claim 1 wherein the nominal illumination angle is empirically determined.

3. A method as in claim 1 wherein the nominal illumination angle is mathematically determined.

4. A method as in claim 1 wherein the light source is positioned to subtend less than the entire object.

5. A light source for a manufacturing inspection system, the light source for illuminating an object, wherein the object has a nontrivial bi-directional reflectance distribution function and includes a nominal illumination angle comprising:
a plurality of discrete light sources arranged in two dimensions and positioned at an angle complementary to the nominal illumination angle.

6. A light source as in claim 5 wherein the discrete light sources are LEDs.

7. A light source as in claim 6 wherein the LEDs are mounted to a flexible printed circuit board, and the circuit board is in the shape of a cone such that the plane of the cone is positioned an angle complementary to the nominal angle.

8. A light source as in claim 6 wherein the LEDs are mounted to at least two rigid circuit boards, the circuit boards being symmetrically positioned around the object at an angle complementary to the nominal angle.

9. A device for inspecting semiconductor devices, the semiconductor devices including a nontrivial bi-directional reflectance distribution function and including a nominal illumination angle, the device including a sensing element and a lens arrangement, the improvement comprising:
a two dimensional light source positioned at an angle complementary to the nominal illumination angle.

10. A device as in claim 9 wherein the light source is a two dimensional collection of LEDs.

11. A device as in claim 10 wherein the collection of LEDs is arranged as a cone.
